(19) United States
(12) Patent Application Publication
(10) Pub. No.: US 2005/0087537 A1
(43) Pub. Date: Apr. 28, 2005

(54) High pressure container and manufacture thereof

(75) Inventors: Masahiko Kimbara, Kariya-shi (JP); Daigoro Mori, Mishima-shi (JP); Makoto Tsuzuki, Kariya-shi (JP); Akiko Kumano, Kariya-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 10/967,187

(22) Filed: Oct. 19, 2004

(30) Foreign Application Priority Data
Oct. 22, 2003 (JP) 2003-361781

(51) Int. Cl. F17C 1/02

(52) U.S. Cl. 220/586

(57) ABSTRACT

A high pressure tank 10 comprises a metal liner 20 having a desired tank shape; and a composite material shell 30 formed on the periphery of the metal liner 20. The metal liner 20 comprises a cylindrical barrel portion 21, a mouthpiece 22 located at each of two end portions, and a cap portion 23 connecting barrel portion 21 with mouthpiece 22. Extensible portions 211 of bellows configuration are formed along the entire length of the metal liner 20 in the axial (lengthwise) direction. The extensible portions 211 impart elastic action through opening and closing (deformation) of their basal portions 211b, thereby preventing slippage from occurring between the metal barrel portion 21 and the composite material shell 30 when the high pressure tank 10 expands and contracts.

### BACKGROUND OF THE INVENTION

1. Field of the Invention

The present invention relates to a high pressure container, and to a method for manufacturing a high pressure container.

2. Description of the Related Art

High pressure containers constructed of a metal liner sheathed in a shell of composite material instead of the conventional steel have become commercially viable as high pressure containers, mainly for storing gas.

High pressure containers that employ a metal liner have a problem of fatigue of the metal liner occurring with expansion and contraction of the container during filling with and discharge of gas. With shells of composite material on the other hand, reducing the amount of fiber in order to lower cost and weight has the effect of increasing the amount of expansion and contraction, limiting the number of times that the container is allowed to be filled and discharged.

Thus, there has been proposed a pressurized container having a bowed portion in a section of the metal liner, for ameliorating fluctuation occurring to the axial direction due to fluctuation in internally pressure.

However, with the technology described above, since only a section of the metal liner has a bowed portion that permits appreciable deformation (elastic deformation), the extent of deformation of the metal liner differs from the extent of deformation of the composite material shell, producing slippage between the two. Accordingly, under high planar pressure shear force is exerted between the metal liner and the composite material shell, producing friction in some slippage portions, while in portions that do not slide the extent of deformation of the metal liner and composite material shell remains substantially the same; accordingly it was not possible to eliminate fatigue constraints in the metal liner.

### SUMMARY OF THE INVENTION

It is therefore an object of the present invention to address the aforementioned issues by providing a high pressure container wherein deformation of the metal liner and of the composite material shell are substantially equal, preventing slippage from occurring between the metal liner and the composite material shell.

In a first aspect thereof for addressing the problem, the invention provides a high pressure container. The high pressure container pertaining to the first aspect of the invention comprises a metal liner having a hollow barrel portion provided over the entire axial length thereof with axially deformable portions permitting elastic deformation in the axial direction, and end portions; and a composite material shell enveloping the periphery of said metal liner.

According to the high pressure container pertaining to the first aspect of the invention, axially deformable portions permitting elastic deformation in the axial direction is provided along the entire axial length of a hollow barrel portion, whereby deformation of the metal liner and of the composite material shell in the high pressure container can be made substantially equal, preventing slippage in the axial direction from occurring between the metal liner and the composite material shell.

In the high pressure container pertaining to the first aspect of the invention, the axially deformable portion may be integrally formed with a bellows configuration in said barrel portion, and said end portions may be integrally formed with said barrel portion. In this case, by means of elastic deformation of the axially deformable portion of bellows configuration, the barrel portion of the metal liner is permitted to undergo expansion and contraction in association with axial expansion and contraction of the composite material shell.

In the high pressure container pertaining to the first aspect of the invention, said metal liner may be formed by means of a plurality of barrel constituent elements that constitute said axially deformable portions as well as forming said barrel portion; and end portion constituent elements forming said end portions separate from said barrel portion and disposed sandwiching said plurality of constituent elements. In this case, axial expansion and contraction of the metal liner barrel in association with axial expansion and contraction of the composite material shell is permitted by the axially deformable portion composed of a plurality of barrel constituent elements. The shape of the barrel constituent elements may be selected freely.

In the high pressure container pertaining to the first aspect of the invention, said barrel portion may have around the entire circumference thereof a diametrically deformable portion permitting elastic deformation in the diametrical direction. In this case, diametrical expansion and contraction of the metal liner barrel in association with expansion and contraction of the composite material shell in the diametrical (circumferential) direction is provided by a diametrically deformable portion. Accordingly, slippage in the diametrical direction can be prevented from occurring between the metal liner and the composite material shell.

The invention in a second aspect thereof provides a high pressure container. The high pressure container pertaining to the second aspect of the invention is characterized by comprising a composite material shell; and a metal liner enveloped by said composite material shell and having a hollow barrel portion undergoing elastic change over the entire axial length in accordance with axial elastic change of said composite material shell, and end portions.

According to the high pressure container pertaining to the second aspect of the invention, since the hollow barrel portion undergoes elastic change over the entire axial length in accordance with axial elastic change of the composite material shell, deformation of the metal liner and of the composite material shell in the high pressure container can be made substantially equal, preventing slippage in the axial direction from occurring between the metal liner and the composite material shell.

In the high pressure container pertaining to the second aspect of the invention, the barrel portion may be integrally formed with a bellows configuration, and said end portion integrally formed with said barrel portion. In this case, by means of elastic deformation of the barrel portion of bellows configuration, the barrel portion of the metal liner is permitted to undergo expansion and contraction in association with axial expansion and contraction of the composite material shell.

In the high pressure container pertaining to the second aspect of the invention, said metal liner may be formed by a plurality of barrel constituent elements forming said barrel portion; and by end portion constituent elements forming said end portions separate from said barrel portion, and disposed sandwiching said plurality of constituent elements. In this case, axial expansion and contraction of the metal liner barrel in association with axial expansion and contraction of the composite material shell is permitted by the barrel portion composed of a plurality of barrel constituent elements. The shape of the barrel constituent elements may be selected freely.

In the high pressure container pertaining to the second aspect of the invention, said barrel portion may additionally undergo elastic change about the entire circumference thereof in accordance with elastic change of the composite material shell in the circumferential direction. In this case, since the barrel portion undergoes elastic change about the entire circumference thereof in accordance with elastic change of the composite material shell in the circumferential direction, the barrel portion of the metal liner is able to expand and contract in the diametrical direction of the barrel portion in association with expansion and contraction of the composite material shell in the diametrical (circumferential) direction. Accordingly, slippage in the diametrical direction can be prevented from occurring between the metal liner and the composite material shell.

In the high pressure container pertaining to the first or second aspect, said metal liner may be pre-loaded in the axial direction. In this case, the fatigue limit of the metal liner can be increased. Also, where the barrel portion is composed of a plurality of barrel portion constituent elements, an improved level of gas-tight performance between the barrel portion constituent elements may be provided.

In a high pressure container pertaining to the first or second aspect, said metal liner may have an internal reinforcing plate disposed orthogonal to the axial direction thereof. In this case, deformation of the high pressure container in the diametrical direction can be held in check by the reinforcing plate. Additionally, where the reinforcing plate is fabricated of highly heat-conductive material, the rate of heat transfer with respect to the composite material shell can be increased.

The invention in a third aspect thereof provides a high pressure container. The high pressure container pertaining to the third aspect of the invention is characterized by comprising a metal liner having a hollow barrel portion provided over the entire circumference thereof with diametrically deformable portions permitting elastic deformation in the diametrical direction, and end portions; and a composite material shell enveloping the periphery of said metal liner.

According to the high pressure container pertaining to the third aspect of the invention, the hollow barrel portion is provided over the entire circumference thereof with diametrically deformable portions, whereby deformation of the metal liner and of the composite material shell in the high pressure container can be made substantially equal, preventing slippage in the diametrical direction from occurring between the metal liner and the composite material shell.

The invention in a fourth aspect thereof provides a high pressure container. The high pressure container pertaining to the fourth aspect of the invention is characterized by comprising a composite material shell; and a metal liner enveloped by said composite material shell and having a hollow barrel portion undergoing elastic change over the entire circumference in accordance with circumferential elastic change of said composite material shell, and end portions.

According to the high pressure container pertaining to the fourth aspect of the invention, the hollow barrel portion undergoes elastic change over the entire circumference in accordance with circumferential elastic change of the composite material shell, whereby deformation of the metal liner and of the composite material shell in the high pressure container can be made substantially equal, preventing slippage in the diametrical direction from occurring between the metal liner and the composite material shell.

In a high pressure container pertaining to any of the first to fourth aspects, said metal liner interior may contain a hydrogen-storage alloy. In this case, it becomes possible to increase the fill level of the hydrogen used to fill the container.

The invention in a fifth aspect thereof provides a method for manufacturing a high pressure container. The method for manufacturing a high pressure container pertaining to the fifth aspect of the invention comprises arraying in a line a plurality of barrel portion constituent elements for making up a barrel portion; arranging an end portion constituent element for making up an end portion, at each of the two ends of said plurality of barrel portion constituent elements; subjecting said end portion constituent elements to loading towards said barrel portion constituent elements; in a loaded state, wrapping said barrel portion constituent elements and said end portion constituent elements with reinforcing fiber; and securing said wrapped reinforcing fiber with a resin agent.

According to the method for manufacturing a high pressure container pertaining to the fifth aspect of the invention, it is possible to manufacture high pressure containers pertaining to the first to fourth aspects.

The invention in a sixth aspect thereof provides a high pressure container. The high pressure container pertaining to the sixth aspect of the invention is characterized by comprising a hollow metal liner barrel portion having an indented cross section over the entire axial direction, entire circumferential direction, or entire axial and circumferential direction, so that when subjected to deformation over the entire axial direction, entire circumferential direction, or entire axial and circumferential direction permits elastic change greater than it would be if composed of a flat surface; two end portions continuous with said metal liner; and a composite material shell enveloping said metal liner and said end portions.

According to the high pressure container pertaining to the sixth aspect of the invention, there is provided a hollow metal liner barrel portion having an indented cross section over the entire axial direction, entire circumferential direction, or entire axial and circumferential direction, so that when subjected to deformation over the entire axial direction, entire circumferential direction, or entire axial and circumferential direction permits elastic change greater than would be if composed of a flat surface, whereby deformation of the metal liner and of the composite material shell in the high pressure container can be made substantially equal, preventing slippage in the axial and circumferential directions from occurring between the metal liner and the composite material shell.

In the high pressure container pertaining to the sixth aspect, the gap between outer circumferential face of said metal liner barrel portion and the inner circumferential face of said composite material shell may be filled with resin or rubber.

In the high pressure container pertaining to the sixth aspect, said metal liner barrel portion and said two end portions may be integrally formed.

In the high pressure container pertaining to the sixth aspect, said metal liner barrel portion may be composed of a plurality of barrel portion constituent elements, said constituent elements preventing leakage of gas from said metal liner barrel portion by means of contact, sealing material, or welding.

### BRIEF DESCRIPTION OF THE DRAWINGS

The following description of the high pressure container and high pressure container manufacturing method pertaining to the invention through working examples makes reference to the accompanying drawings, wherein

FIG. 1 is a partly sectional view illustrating the interior of a high pressure tank pertaining to a first embodiment;

FIG. 2 is an illustration showing the exterior of the high pressure tank pertaining to the first embodiment;

FIG. 3 is an illustration showing Variation 1 of the high pressure tank pertaining to the first embodiment;

FIG. 4 is a detail illustration showing details of the interior of the high pressure tank pertaining to a second embodiment;

FIG. 5 is an illustration showing a first variation of the high pressure tank pertaining to the second embodiment;

FIG. 6 is an illustration showing a second variation of the high pressure tank pertaining to the second embodiment;

FIG. 7 is an illustration showing a third variation of the high pressure tank pertaining to the second embodiment;

FIG. 8 is an illustration showing a fourth variation of the high pressure tank pertaining to the second embodiment;

FIG. 9 is an illustration showing a fifth variation of the high pressure tank pertaining to the second embodiment;

FIG. 10 is a flowchart showing the manufacturing process for the high pressure container pertaining to the second embodiment;

FIG. 11 is an illustration showing the manufacturing process for the high pressure container pertaining to the second embodiment;

FIG. 12 is an illustration showing the manufacturing process for the high pressure container pertaining to the second embodiment;

FIG. 13 is an illustration showing a sixth variation of the high pressure tank pertaining to the second embodiment;

FIG. 14 is a detail illustration showing details of the interior of the high pressure tank pertaining to a third embodiment;

FIG. 15 is an illustration showing internal arrangement of the high pressure container pertaining to a fourth embodiment;

FIG. 16 is a detail illustration showing a method for joining the disk and barrel portion constituent elements in the high pressure container shown in FIG. 15;

FIG. 17 is a detail illustration showing another method for joining the disk and barrel portion constituent elements in the high pressure container shown in FIG. 15;

FIG. 18 is an illustration showing a first variation of the high pressure tank pertaining to the fourth embodiment;

FIG. 19 is a detail illustration showing another method for joining the disk and barrel portion constituent elements in the high pressure container pertaining to the fourth embodiment;

FIG. 20 is an illustration showing a second variation of the high pressure tank pertaining to the fourth embodiment;

FIG. 21 is a detail illustration showing details of the interior of the high pressure tank pertaining to a fifth embodiment;

FIG. 22 is an illustration showing internal arrangement of the high pressure container pertaining to a sixth embodiment;

FIG. 23 is an end view showing a fragmentary transverse section of the high pressure container pertaining to the sixth embodiment;

FIG. 24 is an end view showing another fragmentary transverse section of the high pressure container pertaining to the sixth embodiment;

FIG. 25 is an illustration showing internal arrangement of the high pressure container pertaining to a seventh embodiment; and

FIG. 26 is an end view showing a fragmentary transverse section of the high pressure container pertaining to the seventh embodiment.

### DESCRIPTION OF THE PREFERRED EMBODIMENTS

First Embodiment

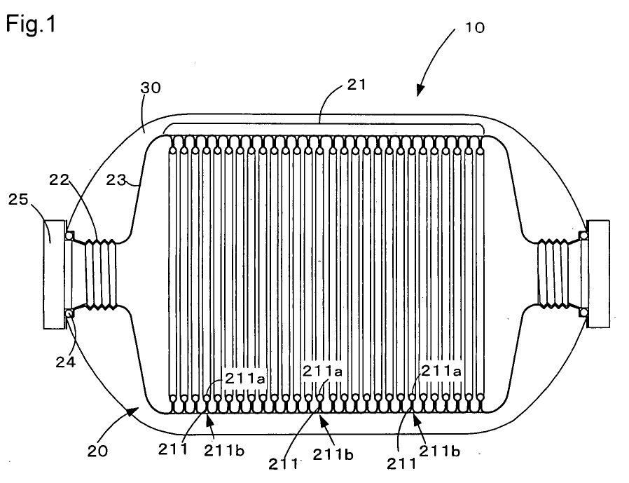

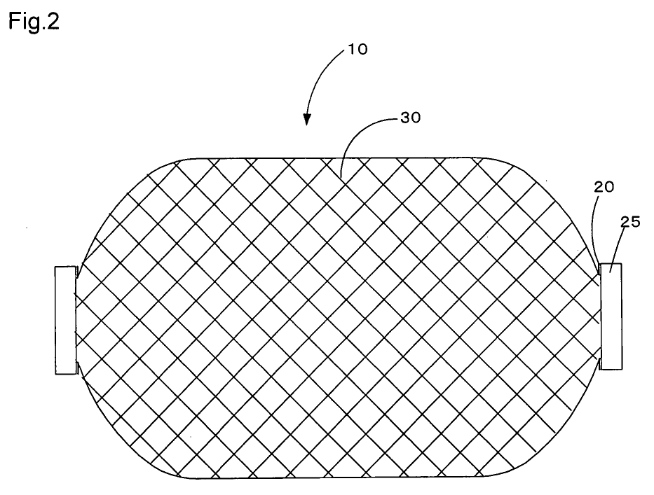

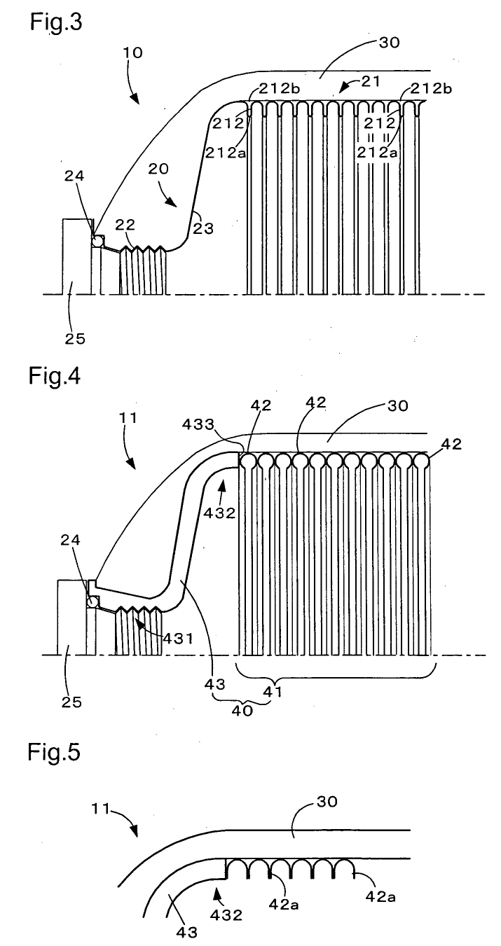

The following description of the high pressure tank pertaining to the first embodiment makes reference to FIGS. 1-3. FIG. 1 is a partly sectional view illustrating the interior of a high pressure tank pertaining to the first embodiment. FIG. 2 is an illustration showing the exterior of the high pressure tank pertaining to the first embodiment. FIG. 3 is an illustration showing Variation 1 of the high pressure tank pertaining to the first embodiment.

As shown in FIG. 2, the high pressure tank 10 pertaining to the first embodiment has a cylindrical shape; and as shown in FIG. 1 comprises a metal liner 20 having the required tank shape, and a composite material shell 30 formed on the periphery of the metal liner 20. The metal liner 20 may be fabricated of stainless steel or aluminum, for example.

The metal liner 20 comprises a cylindrical barrel portion 21, a mouthpiece 22 located at each of two end portions, and a cap portion 23 connecting barrel portion 21 with mouthpiece 22. In the metal liner 20 pertaining to this working example the barrel portion 21, mouthpieces 22 and cap portions 23 are integrally molded. As shown in FIG. 1, barrel portion 21 has extensible segments 211 of bellows configuration expanding over the entire length of the metal liner 20 in the axial (lengthwise) direction thereof. The distal end portions 211a of extensible segments 211 have small-diameter doubled-back configuration so as to avoid plastic deformation due to internal pressure.

By means of elastic action imparted by opening and closing (deformation) of their basal portions 211b, the extensible segments 211 prevent slippage from occurring between the metal barrel portion 21 and the composite material shell 30 when the high pressure tank 10 expands and contracts. In this working example, barrel portion 21 has extensible segments 211 over the entire length thereof, and is thus able to deform over its entire length in association with deformation of the composite material shell 30. That is, the level of extension required of the barrel portion 21 is distributed over the entire length of the barrel portion 21 by means of the extensible segments 211.

The composite material shell 30 is formed by wrapping the periphery of the metal liner 20 with reinforcing fibers, for example, carbon fiber or ceramic fiber, by a helical winding and hoop winding method, and then fixed in place by impregnation with resin such as an epoxy resin. Accordingly, the composite material shell 30 will have different layer sectional profile depending on the winding method; in the drawings herein, the layer sectional profile is not depicted in any detail. When wrapping the metal liner 20 with reinforcing fibers, it is important to take care so that the reinforcing characteristics of the reinforcing fibers are effectively realized.

After forming the composite material shell 30 on the metal liner 20, a connector valve 25 is installed on the metal liner 20 mouthpiece 22 via an O-ring 24 to complete the high pressure tank 10.

Since the extensible segments 211 need only be formed so as to impart to barrel portion 21 elastic change similar to that of composite material shell 30, they may also be formed as shown in FIG. 3, for example. The high pressure tank 10 shown in FIG. 3 has extensible segments 212 generally of “U” shape, having distal end portions 212a of small-diameter doubled-back configuration, and imparting elastic action by means of opening and closing (deformation) of their basal portions 212b.

As noted, according to the high pressure tank 10 of the first embodiment, since extensible segments 211 are formed over the entire length of the barrel portion 21, when the high pressure tank 10 undergoes expansion and contraction in the axial direction as it is filled with or discharges its contents, e.g., a gas, slippage occurring in the axial direction between the barrel portion 21 (metal liner 20) and the composite material shell 30 can be prevented. That is, barrel portion 21, by being provided with extensible segments 211 over the entire length of barrel portion 21, enables the metal liner 20 to extend and contract evenly in the axial direction in the same way that the composite material shell 30 extends and contracts evenly in the axial direction in association with expansion and contraction of the high pressure tank 10, so that slippage occurring in the axial direction between the barrel portion 21 and the composite material shell 30 can be prevented.

By preventing slippage between the barrel portion 21 (metal liner 20) and the composite material shell 30, it becomes possible to prevent friction from being produced between the two 21 (20), 30 so that wear of the barrel portion 21 (metal liner 20) and composite material shell 30 occurring in association with such friction may be prevented. As a result, the life of the high pressure tank 10 may be extended.

Since the metal liner 20 undergoes elastic change as a result of being provided with extensible segments 211, the fatigue life of the metal liner 20 can be improved.

Second Embodiment

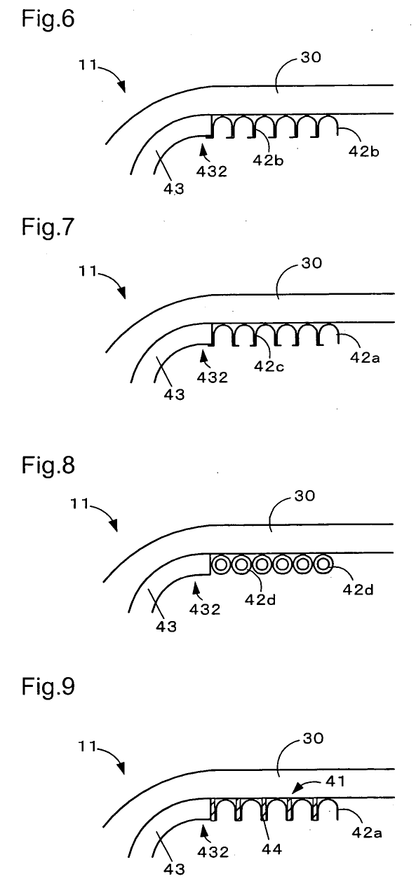

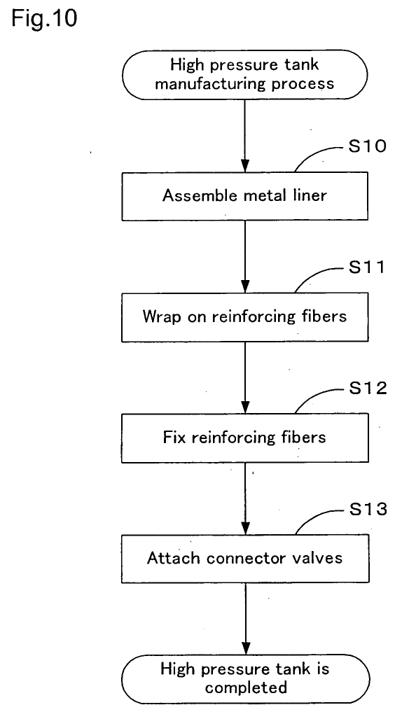

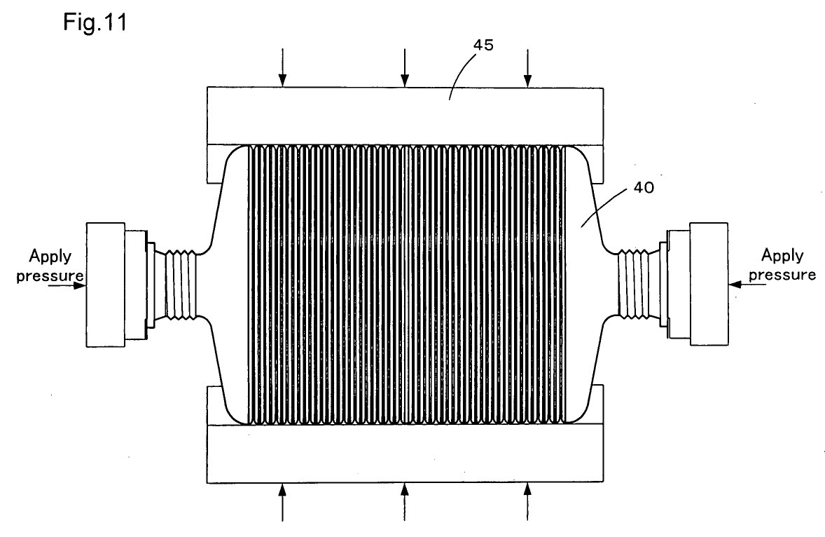

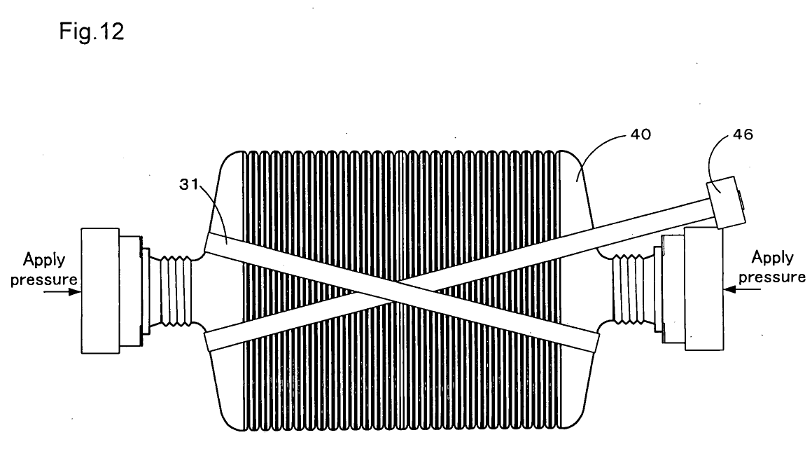

The following description of the high pressure tank pertaining to the second embodiment makes reference to FIGS. 4-12. FIG. 4 is a detail illustration showing details of the interior of the high pressure tank pertaining to the second embodiment. FIG. 5 is an illustration showing a first variation of the high pressure tank pertaining to the second embodiment. FIG. 6 is an illustration showing a second variation of the high pressure tank pertaining to the second embodiment. FIG. 7 is an illustration showing a third variation of the high pressure tank pertaining to the second embodiment. FIG. 8 is an illustration showing a fourth variation of the high pressure tank pertaining to the second embodiment. FIG. 9 is an illustration showing a fifth variation of the high pressure tank pertaining to the second embodiment. FIG. 10 is a flowchart showing the manufacturing process for the high pressure container pertaining to the second embodiment. FIGS. 11 and 12 are illustrations showing the manufacturing process for the high pressure container pertaining to the second embodiment.

The high pressure tank 11 pertaining to the second embodiment differs from the high pressure tank 10 pertaining to the first embodiment in that the barrel portion 41 of metal liner 40 is formed from a plurality of barrel portion constituent elements 42, and the ends of the metal liner 40 are formed by end portion constituent elements 43 that are separate from the barrel portion constituent elements 42. That is, a plurality of barrel portion constituent elements 42 form an extensible section permitting extension and contraction of metal liner 40 in association with axial extension and contraction of composite material shell 30. On the other hand, since the composite material shell 30, connector valve 25, and so on are analogous to those in high pressure tank 10 pertaining to the first embodiment, these are assigned identical symbols and are not described. Additionally, as the outer appearance of high pressure tank 11 is identical to the appearance of the high pressure tank 10 pertaining to the first embodiment, reference may made to FIG. 2 without the need for an additional drawing.

As noted, the barrel portion 41 of the metal liner 40 in the second embodiment is made up of a plurality of barrel portion constituent elements 42. The barrel portion constituent elements 42 may be composed, for example, of ring-shaped members having “C” shaped cross section exhibiting elastic deformation as their open ends move close to or away from one another in response to pressure applied in the axial direction of high pressure tank 11. The barrel portion 41 is made up of barrel portion constituent elements 42 arrayed in plurality in the axial direction of high pressure tank 11. Barrel portion constituent elements 42 may simply be disposed in intimate contact (contact seal), or bonded together by means of an adhesive.

The end portion constituent element 43 making up the metal liner 40 in the second embodiment comprises a first opening 431 corresponding to mouthpiece 22 of the metal liner 20 in the first embodiment, and a second opening 432 having an opening area larger than the first opening 431 and corresponding to cap portion 23 of the metal liner 20 in the first embodiment. By means of the peripheral edge portion 433 of the second opening 432, the end portion constituent element 43 supports barrel portion constituent elements 42 that, of the plurality of barrel portion constituent elements 42 arrayed in a line, are situated at the two ends.

Besides ring-shaped members having “C” shaped cross section, the ring-shaped members depicted in FIGS. 5-9 could be used as the barrel portion constituent elements 42. In a first variation shown in FIG. 5, ring-shaped barrel portion constituent elements 42a having “U” shaped cross section are used. In a second variation shown in FIG. 6, single-flanged, ring-shaped barrel portion constituent elements 42b having “U” shaped cross section are used, with positions of adjacent barrel portion constituent elements 42b relative to one another being regulated by the flanges so as to facilitate lining up of the barrel portion constituent elements 42b. In a third variation shown in FIG. 7, ring-shaped barrel portion constituent elements 42b having “U” shaped cross section and double-flanged ring-shaped barrel portion constituent elements 42c having “U” shaped cross section are used.

In a fourth variation shown in FIG. 8, ring-shaped (pipe ring-shaped) barrel portion constituent elements 42d having “O” shaped cross section are used. Barrel portion constituent elements 42d may have a plurality of holes formed on the inside thereof (i.e. towards the ring center). In this case, internal pressure is applied to the inside of the barrel portion constituent elements 42d through the holes, increasing contact pressure between barrel portion constituent elements 42d so as to improve intimate contact. By improving intimate contact, when barrel portion constituent elements 42d are joined together, the force tending to pull joined portions apart may be reduced.

In a fifth variation shown in FIG. 9, there are employed ring-shaped barrel portion constituent elements 42a and seal elements 44 composed of elastomer, i.e. rubber or Teflon resin. In this variation, the metal barrel portion constituent elements 42a and non-metallic seal elements 44 are disposed in alternating fashion. By interposing seal elements 44, sealing between the barrel portion 41 and composite material shell 30 can be improved.

The following brief description of the manufacturing process for the high pressure tank 11 pertaining to the second embodiment makes reference to FIGS. 10-12. As shown in FIG. 11, first, a plurality of barrel portion constituent elements 42 are lined up according to the required high pressure tank 11 length, and an end constituent element 43 is disposed at each of the two ends of the barrel portion 41 formed by the plurality of barrel portion constituent elements 42, to carry out assembly (formation) of the metal liner 40 (Step S10). When lining up and arranging the barrel portion constituent elements 42 and end portion constituent elements 43 to form the metal liner 40, positioning is carried out using a jig 45 while applying a predetermined level of pressure in the axial direction, as shown in the drawing.

When forming of the metal liner 40 has been completed, as shown in FIG. 12, the assembly is withdrawn from the jig 45 while continuing to maintain pressure in the axial direction, and the metal liner 40 assembly is wrapped with reinforcing fibers 31 using a filament winder 46 (Step S11). When wrapping on the reinforcing fibers 31, helical wind and hoop wind winding methods are used. Typically, hoop winding is used for the barrel portion 41, and helical winding is used for the barrel portion 41 and end portion (end portion constituent elements 43). By wrapping on reinforcing fibers 31, the barrel portion constituent elements 42 and end portion constituent elements 43 are fixed securely in place. In FIG. 12, the filament winder 46 is shown conceptually.

The wrapped on reinforcing fibers 31 are then impregnated with resin such as an epoxy resin to secure the reinforcing fibers 31 and form the composite material shell 30 (Step S12). Finally, the connector valves 25 and other related components are attached (Step S13) to complete the high pressure tank 11.

According to the high pressure tank 11 pertaining to the second embodiment as described above, the following advantages are obtained in addition to those afforded by the high pressure tank 10 pertaining to the first embodiment. While the barrel portion 41 of the metal liner 40 of high pressure tank 11 is formed of a plurality of barrel portion constituent elements 42, since it is manufactured in a preloaded state in the axial direction, gas-tightness among the barrel portion constituent elements 42 can be improved. Also, while the barrel portion constituent elements 42 and end portion constituent elements 43 are contact-sealed, by means of preloading and internal pressure once filled with contents, sealing among the two 42, 43 can be improved and gas-tightness maintained.

Additionally, since the metal liner 40 is subjected to preloading in the axial direction, the fatigue limit of the metal liner 40 can be increased.

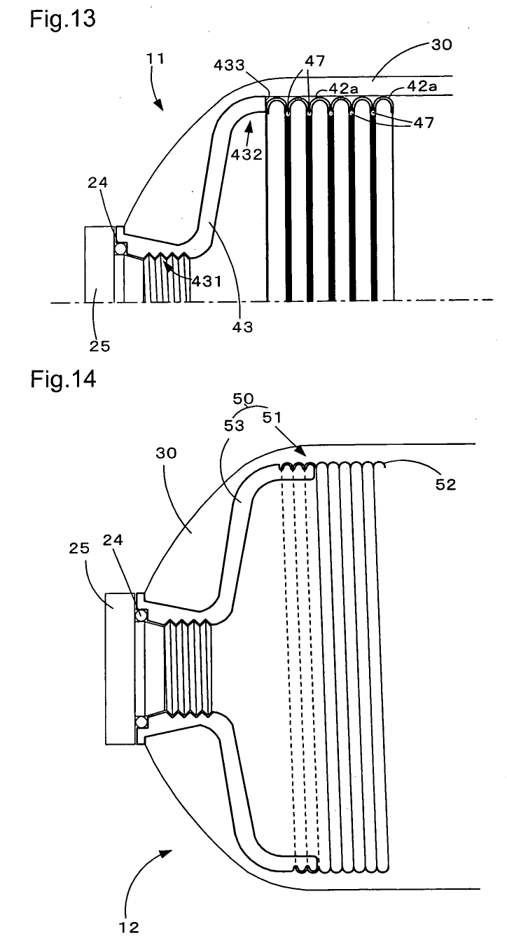

The second embodiment can also be reduced to practice in the manner shown in FIG. 13. FIG. 13 is an illustration showing a sixth variation of the high pressure tank pertaining to the second embodiment. In this sixth variation, in high pressure tank 11 barrel portion constituent elements 42a of “U” shaped cross section are joined not by contact or by bonding, but by means of welding as indicated by weld portions 47. The high pressure tank 11 pertaining to the second embodiment is manufactured in a preloaded state by being wrapped with reinforcing fibers 31, and since the barrel portion constituent elements 42a give elastic deformation, stress concentration in weld portions 47 during expansion and contraction of the high pressure tank 11 can be avoided. Accordingly, metal liner 40 life can be improved even where barrel portion constituent elements 42a are joined by means of welding. Welding may be performed over the entire circumference, or carried out in spot wise fashion.

In the second embodiment, preloading of the metal liner 40 is not limited to the axial direction only, but may be carried out in both the axial and circumferential directions. The means for preloading may consist of either applying mechanical pressure, or using a fluid to reduce pressure in the interior or apply pressure from the outside.

Third Embodiment:

The following description of the high pressure tank pertaining to the third embodiment makes reference to FIG. 14. FIG. 14 is a detail illustration showing details of the interior of the high pressure tank pertaining to the third embodiment. The metal liner 50 of the high pressure tank 12 pertaining to the third embodiment is formed by a barrel portion constituent element 52 that make up an integrally formed barrel portion 51 having a helical groove that functions as extensible portions, and an end portion constituent element 53 that threadably mates with barrel portion constituent element 52. Other constituent elements of the high pressure tank 12 pertaining to the third embodiment are analogous to constituent elements of the high pressure tank 10 pertaining to the first embodiment; accordingly, these are assigned identical symbols and not described.

According to the high pressure tank 12 pertaining to the third embodiment, end portion constituent element 53 is threadably mated with barrel portion constituent element 52 to form the metal liner 50 so that the metal liner 50 can be formed easily. Additionally, since the barrel portion constituent element 52 has a groove that functions as extensible portions and has a sinuous longitudinal section, the high pressure tank 12 pertaining to the third embodiment affords working effects analogous to the high pressure tank pertaining to the first embodiment.

Fourth Embodiment:

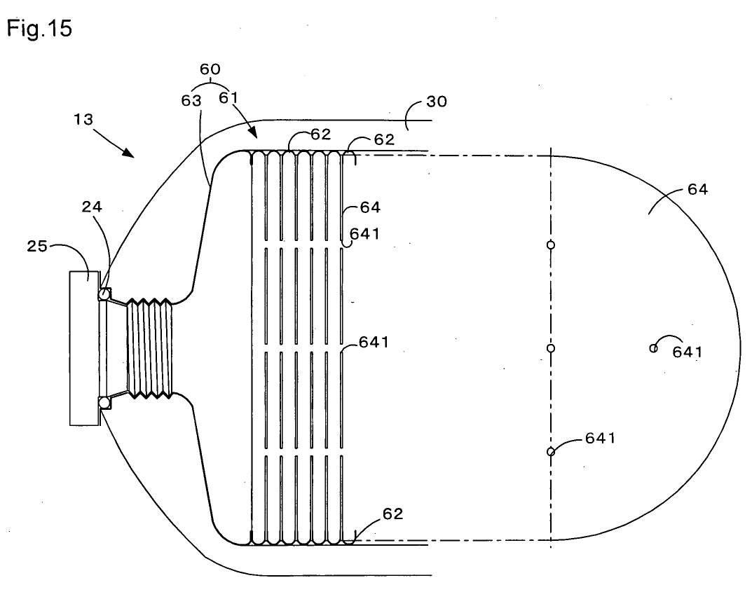

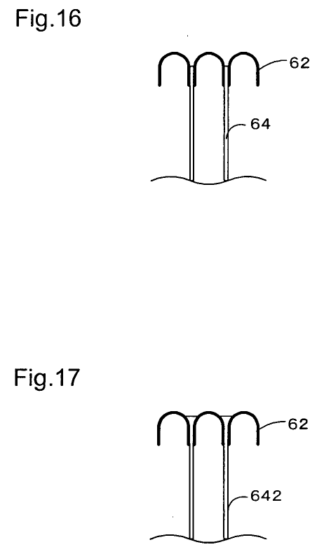

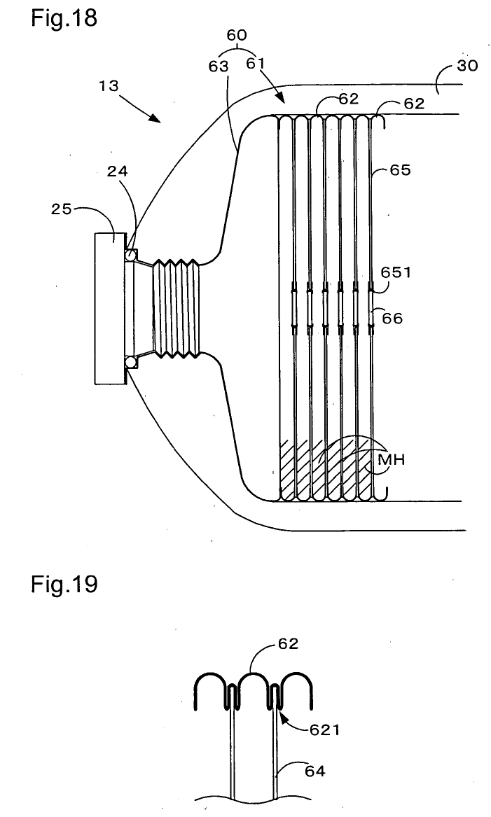

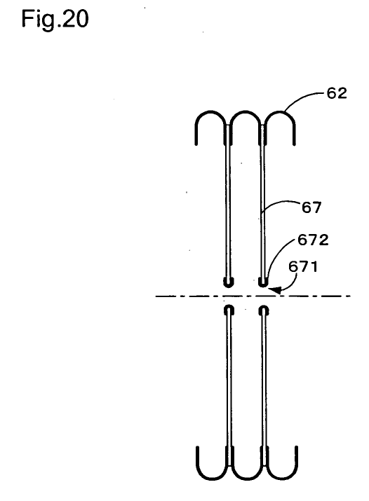

The following description of the high pressure tank pertaining to the fourth embodiment makes reference to FIGS. 15-20. FIG. 15 is an illustration showing internal arrangement of the high pressure container pertaining to the fourth embodiment. FIG. 16 is a detail illustration showing a method for joining the disk and barrel portion constituent elements in the high pressure container shown in FIG. 15. FIG. 17 is a detail illustration showing another method for joining the disk and barrel portion constituent elements in the high pressure container shown in FIG. 15. FIG. 18 is an illustration showing a first variation of the high pressure tank pertaining to the fourth embodiment. FIG. 19 is a detail illustration showing another method for joining the disk and barrel portion constituent elements in the high pressure container pertaining to the fourth embodiment. FIG. 20 is an illustration showing a second variation of the high pressure tank pertaining to the fourth embodiment.

In the high pressure tank 13 pertaining to the fourth embodiment, like the high pressure tank 11 pertaining to The second embodiment, the barrel portion 61 of metal liner 60 is formed of a plurality of barrel portion constituent elements 62 that function as extensible portions, with the two ends of metal liner 60 being formed of end portion constituent elements 63 separate from the barrel portion constituent elements 62. Disks 64 are interposed between barrel portion constituent elements 62. Other constituent elements of the high pressure tank 13 pertaining to the fourth embodiment are analogous to constituent elements of the high pressure tank 10 pertaining to the first embodiment or the high pressure tank 11 pertaining to the second embodiment; accordingly, these are assigned identical symbols and not described.

As shown in FIG. 15, for example, the barrel portion constituent elements 62 in the fourth embodiment are ring-shaped members having “U” shaped cross section exhibiting elastic deformation as their open ends move close to or away from one another due to stress applied in the axial direction of high pressure tank 13. With disks 64 sandwiched between the barrel portion constituent elements 62, a plurality of barrel portion constituent elements 62 are lined up in the axial direction of high pressure tank 13 to constitute the barrel portion 61.

Disks 64 consist of a metal such as copper or aluminum, or of FRP; as shown in FIG. 15, they have a plurality of holes 641 permitting movement of gas contents. By providing disks 64, deformation of high pressure tank 13 in the circumferential direction can be controlled. In this working example, barrel portion constituent elements 62 can be formed of stainless steel, aluminum or the like; however, stainless steel, while having high strength, is difficult to join. Accordingly, where stainless steel is used for the barrel portion constituent elements 62, these may be clad materials coated with copper or aluminum in order to improving joinability with disks 64.

Also, since typically gases permeate easily through the composite material shell 30, disk 64 surfaces may be coated in order to prevent permeation of gas contents. Coating materials for use in coating could include fluororesins and other such resins, or aluminum, gold, copper and other metals.

As shown in FIG. 16, the barrel portion constituent elements 62 and disks 64 are joined to one another, with the barrel portion constituent element 62 and end portion constituent element 63 at each end of the barrel portion 61 being contact sealed. Or, where disks 64 are situated at both ends of the barrel portion 61, the disks 64 and end portion constituent elements 63 are joined. Also, where there are employed disks 642 of a shape increasing in thickness towards the peripheral edge in proximity to the perimeter as shown in FIG. 17, a contact seal can be produced between barrel portion constituent elements 62 and disks 64. In this case, the internal pressure of the high pressure tank 13 will increase the contact pressure between barrel portion constituent elements 62 and disks 64, so that ample sealing characteristics can be obtained through contact sealing. Where the metal liner 60 is preloaded during manufacture of high pressure tank 13, contact pressure will be increased by preloading as well, in addition to internal pressure of the high pressure tank 13.

As shown in FIG. 18, the high pressure tank 13 pertaining to the fourth embodiment may incorporate a hydrogen-storage alloy MH, and have disposed in the center portion thereof disks 65 having large openings 651. In the opening 651 of each disk 65 is disposed a filter 66 for isolating on a per-disk 65 basis the hydrogen-storage alloy MH which has been evenly distributed therein. By providing disks 65, it is possible to improve the rate of transfer to the composite material shell 30 of heat generated in the hydrogen-storage alloy MH during filling with hydrogen. It is known that when the container internal temperature of high pressure tank 13 rises, the storable charge level drops; according to this variation, it is possible to lower the container internal temperature of high pressure tank 13 so that the hydrogen charge level for high pressure tank 13 can be increased.

Another method for joining the barrel portion constituent elements 62 and disks 64 in the high pressure tank 13 pertaining to the fourth embodiment is described with reference to FIG. 19. In the joining method shown in FIG. 19, disk mounting portions 621 for accommodating the edges of disks 64 are formed on the barrel portion constituent elements 62, so that the barrel portion constituent elements 62 and disks are joined, bonded, and mated together at these disk mounting portions 621.

The following description of a second variation of the high pressure tank pertaining to the fourth embodiment refers to FIG. 20. In this second variation, in order to prevent a stress concentration from forming in the opening 671 provided to disk 67, a reinforcing plate 672 covers or is joined to the opening 671. By providing a reinforcing plate 672, strength of the opening 671 may be improved, and concentration of stress at the opening 671 prevented.

As described hereinabove, according to the high pressure tank 13 pertaining to the fourth embodiment, disks 64, 65, 67 are disposed inside the metal liner 60, whereby deformation in the diametrical direction of metal liner 60 (high pressure tank 13) in association with expansion of high pressure tank 13 may be prevented. Also, since barrel portion constituent elements 62 have “U” shaped cross section, the high pressure tank 13 pertaining to the fourth embodiment affords working effects analogous to the high pressure tank 10 pertaining to the first embodiment.

Fifth Embodiment:

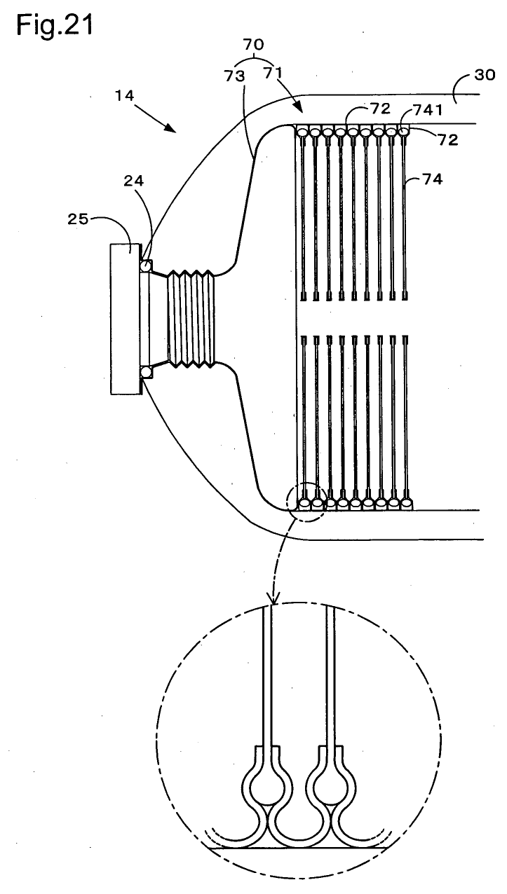

The following description of the high pressure tank pertaining to the fifth embodiment makes reference to FIG. 21. FIG. 21 is a detail illustration showing details of the interior of the high pressure tank pertaining to the fifth embodiment.

In the high pressure tank 14 pertaining to the fifth embodiment, metal liner 70 comprises barrel portion constituent elements 72 that make up a barrel portion 71, end portion constituent elements 73 supporting the barrel portion constituent elements 72 at both ends, and disks 74 retained by the barrel portion constituent elements 72. Since the composite material shell 30, connector valves 25 and so on are analogous to those of the high pressure tank 10 pertaining to the first embodiment, these are assigned identical symbols and not described.

As shown in FIG. 21, in the high pressure tank 14 pertaining to the fifth embodiment, the barrel portion constituent elements 72 retain the disks 74 by means of enveloping the peripheral edge of the disk 74. To ensure reliable interlocking of barrel portion constituent elements 72 with disks 74, it is preferable for the peripheral edge portion 741 of a disk 74 to have increased thickness. Since barrel portion constituent elements 72 are subjected to internal pressure of high pressure tank 14 and pinch the peripheral edge portions 741 of disks 74, it is required that gas-tightness be maintained reliably between barrel portion constituent elements 72 and disks 74, that is, that there be a sufficient pressure differential between internal pressure within the high pressure tank 14 and pressure in spaces defined by the barrel portion constituent elements 72 and disks 74.

Sixth Embodiment:

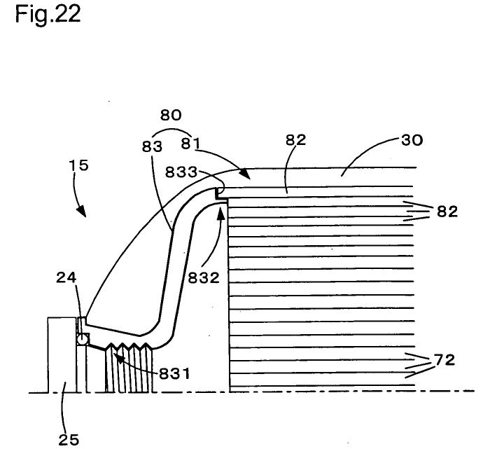

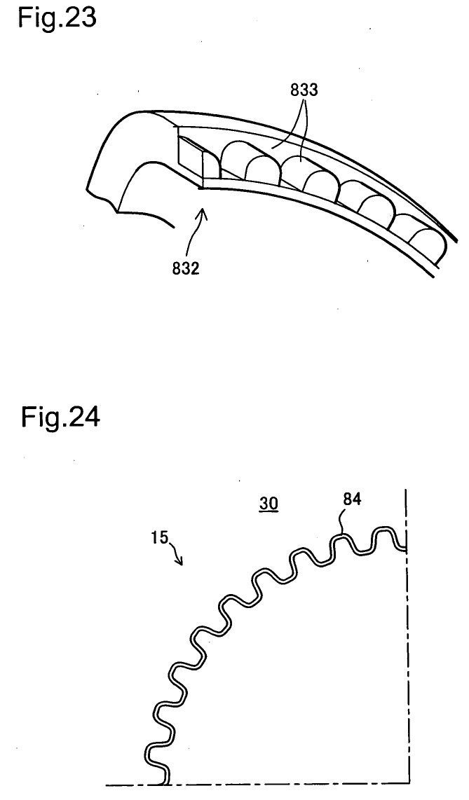

The following description of the high pressure tank pertaining to the fifth embodiment makes reference to FIGS. 22-24. FIG. 22 is an illustration showing internal arrangement of the high pressure container pertaining to the sixth embodiment. FIG. 23 is an end view showing a fragmentary transverse section of the high pressure container pertaining to the sixth embodiment. FIG. 24 is an end view showing another fragmentary transverse section of the high pressure container pertaining to the sixth embodiment. In FIGS. 23 and 24, only essential constituent elements are shown in order to facilitate the description.

In the high pressure tank 15 pertaining to the sixth embodiment, barrel portion 81 of metal liner 80 is formed from a plurality of linear barrel portion constituent elements 82, with the two ends of metal liner 80 being formed from end portion constituent elements 83 separate from portion constituent elements 82. Whereas in the high pressure tank 11 pertaining to the second embodiment, a plurality of ring-shaped barrel portion constituent elements 41 are employed to enable metal liner 40 to extend and contract in the axial direction in association with extension and contraction of composite material shell 30 in the axial direction, in the high pressure tank 15 pertaining to the sixth embodiment, a plurality of linear barrel portion constituent elements 82 are employed to enable the metal liner 80 to extend and contract in the diametrical direction in association with extension and contraction of composite material shell 30 in the diametrical (circumferential) direction. Since the composite material shell 30, connector valves 25 and so on are analogous to those of the high pressure tank 10 pertaining to the first embodiment, these are assigned identical symbols and not described. Additionally, as the outer appearance of high pressure tank 15 is identical to the appearance of the high pressure tank 10 pertaining to the first embodiment, reference may made to FIG. 2 without the need for an additional drawing.

As noted, the barrel portion 81 of metal liner 80 in the fifth embodiment is composed of a plurality of barrel portion constituent elements 82. As shown in cross section in FIG. 23, for example, the barrel portion constituent elements 82 may be members of linear shape having “U” shaped cross section, exhibiting elastic deformation as their open ends move closer to or away from one another due to stress applied in the diametrical direction of high pressure tank 15. The barrel portion 81 is made up of barrel portion constituent elements 82 arrayed in plurality in the diametrical (circumferential) direction of high pressure tank 15. Barrel portion constituent elements 82 may simply be disposed in intimate contact (contact seal), bonded together by means of an adhesive, or joined by welding.

End portion constituent element 83 making up the metal liner 80 in the sixth embodiment has a first opening 831 corresponding to mouthpiece 22 of the metal liner 20 in the first embodiment and a second opening 832 having an opening area larger than the first opening 831 and corresponding to cap portion 23 of the metal liner 20 in the first embodiment. End portion constituent elements 83 support the two ends of the line of barrel portion constituent elements 82, by means of the peripheral edge 833 of the second opening 832.

The high pressure tank 15 pertaining to the sixth embodiment may also be realized according to the first variation illustrated in FIG. 24. The barrel portion constituent elements 84 in the first variation have corrugated configuration. The barrel portion constituent elements 84 may be produced by machining a single plate into corrugated configuration, for example. In this case, extension and contraction of the metal liner 80 in the diametrical direction in association with extension and contraction of the composite material shell 30 in the diametrical direction is realized through extension and contraction of the corrugated portions.

Alternatively, barrel portion constituent elements 84 may have circular cross section, “C” shaped cross section, or “Q” shaped cross section.

As described above, according to the high pressure tank 15 pertaining to the sixth embodiment, by means of barrel portion constituent elements 82 extensible portions are formed over the entire diametrical direction (entire circumference) of the metal liner 80, whereby in the event of expansion or contraction of high pressure tank 15 in association with filling or discharge of contents (e.g. a gas), it is nevertheless possible to prevent slippage from occurring in the diametrical direction between the barrel portion 81 (metal liner 80) and the composite material shell 30. That is, since the barrel portion 81 is formed by linear barrel portion constituent elements 82 of “U” shaped cross section functioning as extensible portions, it can undergo elastic change in the circumferential direction in response to a lower level of stress. As a result, the metal liner 80 can uniformly extend and contract in the circumferential direction in similar fashion to the composite material shell 30 uniformly extending and contracting in the circumferential direction in association with expansion or contraction of high pressure tank 15, so that slippage occurring between the barrel portion 81 and the composite material shell 30 can be prevented.

By preventing slippage occurring between the barrel portion 81 (metal liner 80) and the composite material shell 30, it becomes possible to prevent friction from being produced between the two 81, 30 so that wear of the barrel portion 81 and composite material shell 30 occurring in association with such friction may be prevented. As a result, the life of the high pressure tank 15 may be extended.

Seventh Embodiment:

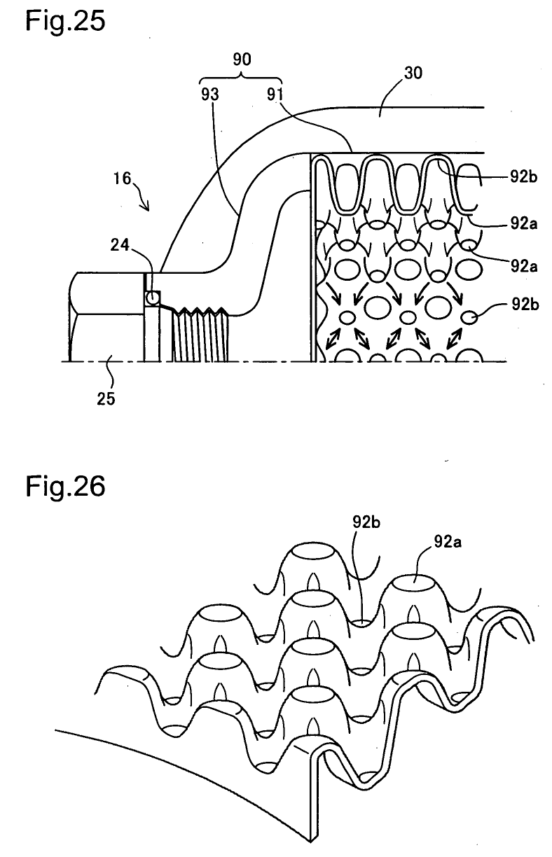

The following description of the high pressure tank pertaining to the seventh embodiment makes reference to FIGS. 25 and 26. FIG. 25 is an illustration showing internal arrangement of the high pressure container pertaining to the seventh embodiment. FIG. 26 is an end view showing a fragmentary transverse section of the high pressure container pertaining to the seventh embodiment. In FIGS. 25 and 26, only essential constituent elements are shown in order to facilitate the description.

In the high pressure tank 16 pertaining to the seventh embodiment, the barrel portion 91 of metal liner 90 is formed by means of a plurality of linear or ring-shaped barrel portion constituent elements 92 having alternating convex and concave portions, with the two ends of the metal liner 90 being formed by end portion constituent elements 93 separate from the barrel portion constituent elements 92. Whereas in the working examples described previously, there were described metal liners extensible in either the axial direction or the diametrical direction in association with extension of the composite material shell 30 in either the axial direction or the diametrical direction, with the high pressure tank pertaining to the seventh embodiment, the metal liner 90 is extensible in both the axial and diametrical directions in association with extension in the axial and diametrical (circumferential) directions occurring in the composite material shell 30. Since the composite material shell 30, connector valves 25 and so on are analogous to those of the high pressure tank 10 pertaining to the first embodiment, these are assigned identical symbols and not described. Additionally, as the outer appearance of high pressure tank 16 is identical to the appearance of the high pressure tank 10 pertaining to the first embodiment, reference may made to FIG. 2 without the need for an additional drawing.

In the high pressure tank 16 pertaining to the seventh embodiment, metal liner 90 comprises a barrel portion 91 having plurality of concave portions 92a and convex portions 92b in an alternating arrangement. Barrel portion 91 may be formed, for example, by press forming a plate-shaped member to produce the concave portions 92a and convex portions 92b. Alternatively, where the barrel portion 91 is composed of a plurality of ring-shaped barrel portion constituent elements, the plurality of barrel portion constituent elements are lined up in the axial direction, placed in intimate contact, and in a preloaded state are wrapped with reinforcing fibers to secure them in place.

As shown in FIGS. 25 and 26, barrel portion 91 has a corrugated cross section in both the transverse and longitudinal cross sections. Accordingly, the metal liner 90 in the seventh embodiment comprises extensible portions formed by a plurality of concave portions 92a and convex portions 92b over the entire axial length and entire diametrical circumference. Alternatively, barrel portion 91 may be formed of an array of barrel portion constituent elements consisting of corrugated ring-shaped members having “U” or “C” shaped cross section, or of barrel portion constituent elements consisting of corrugated linear members having “U” or “C” shaped cross section, or formed by means of band-shaped members assembled in the axial and diametrical directions into a three-dimensional shape. In any event, it is sufficient that appreciable elastic change be permitted in both the axial and diametrical directions.

As described above, according to the high pressure tank 16 pertaining to the seventh embodiment, extensible portions formed by a plurality of concave portions 92a and convex portions 92b are formed over the entire axial length and entire diametrical circumference of metal liner 90, whereby slippage occurring in both the axial and diametrical directions between the barrel portion 91 (metal liner 90) and composite material shell 30 can be prevented. That is, since barrel portion 91 is formed by a member of plate shape having an alternating arrangement of concave portions 92a and convex portions 92b that function as extensible portions, or by a plurality of ring-shaped barrel portion constituent elements, it can undergo elastic change in the axial and diametrical directions in response to a lower level of stress. As a result, the metal liner 90 can uniformly extend and contract in the circumferential direction in similar fashion to the composite material shell 30 uniformly extending and contracting in the circumferential direction in association with expansion or contraction of high pressure tank 16, so that slippage occurring between the barrel portion 91 and the composite material shell 30 can be prevented.

Other Embodiments:

(1) Whereas in the working examples hereinabove, the use of high pressure tanks 10, 11 having connector valves 25 at both ends was described, connector valve 25 could be provided at one end only.

(2) In the working examples hereinabove, film or tape could be wrapped around the periphery of the metal liner prior to wrapping reinforcing fibers onto the periphery of the metal liner. Alternatively, convex portions (extensible portions) formed on the periphery of a metal liner (barrel portion) could be filled with a resin molding. When fixing the reinforcing fibers using resin, it is possible that resin may fall out from convex portions (extensible portions) formed on the periphery of a metal liner (barrel portion). Falling out of the resin can result in resin-deficient portions (molding defects) in the composite material shell.

To prevent this, convex portions (extensible portions) formed on the periphery of the metal liner (barrel portion) may be covered or sealed off in advance with film, tape, a resin molding, or the like in order to prevent resin-deficient portions (molding defects) from occurring in the composite material shell. Where a resin molding is used, since the concave portions are filled, the contact area between the metal liner and composite material shell is expanded and internal pressure of the high pressure tank is transmitted to a wider area on the composite material shell inner face.

Exemplary film, tape and resin materials are polyethylene, nylon-6, epoxy resins, fiber-reinforced plastics (FRP), and the like. Resin moldings may consist of a previously manufactured resin molding subjected to machining processes, or be produced by flowing resin material into the convex portions (extensible portions) formed on the periphery of the metal liner (barrel portion) to produce shapes conforming to the convex portions.

Whereas the high pressure tank and high pressure tank manufacturing method pertaining to the invention have been shown and described in terms of working examples, the embodiments of the invention set forth herein are intended to aid in understanding of the invention and should not be construed as limiting thereof. Various modifications and improvements are possible without departing from the scope and spirit of the invention as set forth in the claims, and such equivalents will naturally be included in the invention.

1. A high pressure container comprising:
a metal liner having a hollow barrel provided over the entire axial length thereof with axially deformable portions permitting elastic deformation in the axial direction, and end portions; and
a composite material shell enveloping the periphery of said metal liner.

2. A high pressure container according to claim 1 wherein the axially deformable portion is integrally formed with a bellows configuration in said barrel portion and said end portions are integrally formed with said barrel portion.

3. A high pressure container according to claim 1 wherein said metal liner is formed by a plurality of barrel constituent elements that constitute said axially deformable portions as well as forming said barrel portion; and by end portion constituent elements forming said end portions separate from said barrel portion, and disposed sandwiching said plurality of constituent elements.

4. A high pressure container comprising:
a metal liner having a hollow barrel provided over the entire axial length thereof with axially deformable portions permitting elastic deformation in the axial direction, and over the entire circumference thereof with diametrically deformable portions permitting elastic deformation in the diametrical direction, and end portions; and
a composite material shell enveloping the periphery of said metal liner.

5. A high pressure container comprising:
a composite material shell; and
a metal liner enveloped by said composite material shell and having a hollow barrel portion undergoing elastic change over the entire axial length in accordance with axial elastic change of said composite material shell, and end portions.

6. A high pressure container according to claim 5 wherein said barrel portion is integrally formed with a bellows configuration, and said end portions are integrally formed with said barrel portion.

7. A high pressure container according to claim 5 wherein said metal liner is formed by means of a plurality of barrel constituent elements forming said barrel portion; and end portion constituent elements forming said end portions separate from said barrel portion, and disposed sandwiching said plurality of constituent elements.

8. A high pressure container according to claim 5 wherein said barrel portion additionally undergoes elastic change about the entire circumferential length thereof in accordance with elastic change of the composite material shell in the circumferential direction

9. A high pressure container according to claim 1 wherein said metal liner is pre-loaded in the axial direction.

10. A high pressure container according to claim 1 wherein said metal liner has an internal reinforcing plate disposed orthogonal to the axial direction thereof.

11. A high pressure container comprising:
a metal liner having a hollow barrel portion provided over the entire circumference thereof with diametrically deformable portions permitting elastic deformation in the diametrical direction, and end portions; and
a composite material shell enveloping the periphery of said metal liner.

12. A high pressure container comprising:
a composite material shell; and
a metal liner enveloped by said composite material shell and having a hollow barrel portion undergoing elastic change over the entire circumference in accordance with circumferential elastic change of said composite material shell, and end portions.

13. A high pressure container according to claim 5 wherein said metal liner interior contains a hydrogen-storage alloy.

14. A method of manufacturing a high pressure container comprising:
arraying in a line a plurality of barrel portion constituent elements for making up a barrel portion;
arranging an end portion constituent element for making up an end portion, at each of the two ends of said plurality of barrel portion constituent elements;
subjecting said end portion constituent elements to loading towards said barrel portion constituent elements;
in a loaded state, wrapping said barrel portion constituent elements and said end portion constituent elements with reinforcing fiber; and
securing said wrapped reinforcing fiber with a resin agent.

15. A high pressure container comprising:
a hollow metal liner having an indented cross section over the entire axial direction, entire circumferential direction, or entire axial and circumferential direction, so as when subjected to deformation over the entire axial direction, entire circumferential direction, or entire axial and circumferential direction to permit elastic change greater than that permitted by a flat surface;
two end portions continuous with said metal liner; and
a composite material shell enveloping said metal liner and said end portions.

16. A high pressure container according to claim 15 wherein the gap between outer circumferential face of said metal liner and the inner circumferential face of said composite material shell is filled with resin or rubber.

17. A high pressure container according to claim 15 wherein said metal liner barrel portion and said two end portions are integrally formed.

18. A high pressure container according to claim 15 wherein said metal liner barrel portion is composed of a plurality of barrel portion constituent elements,
said constituent elements preventing leakage of gas from said metal liner barrel portion by means of contact, sealing material, or welding.
